(19) United States
(12) Patent Application Publication
(10) Pub. No.: US 2006/0032974 A1
(43) Pub. Date: Feb. 16, 2006

(54) Modular installation kit for auxiliary power unit

(75) Inventor: Nicholas A. Williams, Phoenix, AZ (US)

Correspondence Address: Honeywell International, Inc.;Law Dept. AB2, P.O. Box 2245, Morristown, NJ, 07962-9806, US

(73) Assignee: Honeywell International Inc., Morristown, NJ (US)

(21) Appl. No.: 10/967,972

(22) Filed: Oct. 19, 2004

Related U.S. Application Data
(60) Provisional application No. 60/602,172, filed on Aug. 16, 2004.

(51) Int. Cl. B64D 41/00

(52) U.S. Cl. 244/58

(57) ABSTRACT

A modular installation kit for mounting an auxiliary power unit in an vehicle, the modular installation kit comprising a forward cap having at least one mounting pad attachable to one or more mounting brackets, which are attachable to a vehicle, the forward cap having an inlet hole circumscribed by an auxiliary power unit interface flange which is capable of engaging an inlet to the auxiliary power unit, and providing support for the auxiliary power unit. A method of mounting an auxiliary power unit is also disclosed.

### CROSS REFERENCE TO RELATED APPLICATION

This application claims the benefit of U.S. Provisional Application No. 60/602,172, filed Aug. 16, 2004.

### BACKGROUND OF THE INVENTION

The present invention generally relates to apparatus and methods for a modular installation kit for mounting an auxiliary power unit, such as in a vehicle. More specifically, the present invention relates to apparatus and methods relating to a modular installation kit for small airborne auxiliary power units.

Many modern commercial and business aircraft are equipped with airborne auxiliary power units (APUs). The APU provides electrical and pneumatic power to the aircraft for such tasks as environmental control, lighting, powering electronics, main engine starting, and the like. Because of the size and weight of conventional APUs and the complexity of mounting APUs to aircraft using conventional installation apparatus and methods, smaller aircraft have not been able to take advantage of the benefits and convenience of an airborne APU.

Numerous APUs and methods for mounting APUs are known in the art. For example, U.S. Pat. No. 6,270,309 is directed to a ducted ram air turbine which can be used as an APU on an aircraft. U.S. Pat. No. 6,581,874 to Lemire et al. is directed to a system for supporting an APU in an aircraft tailcone, wherein the APU is supported by a focalized suspension system, the focalized suspension system having a plurality of support means each having a line of action, the lines of action intersecting at the focal point. However, none of the above references provides for a universal mounting kit for an APU, but instead require an APU arranged and dimensioned for a particular space in a particular vehicle.

U.S. Pat. No. 4,043,522 to Vetter is directed to a pod for mounting a turbofan jet propulsion engine on a strut constructed so that a common cowl and portions of the fan air duct and turbine exhaust duct can accommodate a plurality of different turbofan engines that have substantially the same thrust rating but have variations in structural dimensions. However, Vetter does not provide for APU mounting or installation inside an aircraft.

Conventional APU installation thus requires customized mounting to each individual vehicle. Because of the number of parts required to install an APU into a vehicle, and the requirements placed on those parts by various regulatory agencies, having a fully customized APU installation kit for every model of vehicle introduces unnecessary cost into the manufacture of the vehicle. This cost is traditionally acceptable because of the weight benefits realized on medium and large size aircraft. The small size of newly developed APUs may lend themselves to an installation substantially different from those traditionally used in vehicles, such as aircraft equipped with airborne APUS.

As can be seen, there is a need for an installation of an APU provided by a system that minimizes the quantity of vehicle-specific parts required for an APU installation, and therefore reduces the cost and complexity to the operators.

### SUMMARY OF THE INVENTION

In one aspect of the present invention a modular installation kit for mounting an auxiliary power unit comprises a forward cap comprising at least one mounting pad, wherein the at least one mounting pad is attachable to one or more mounting brackets; and an auxiliary power unit interface flange attached to the forward cap and depending axially away from the forward cap, wherein the auxiliary power unit interface flange is capable of engaging the auxiliary power unit, and wherein the auxiliary power unit interface flange is capable of providing support for the auxiliary power unit.

In another aspect of the invention, a modular installation kit for mounting an auxiliary power unit in a vehicle comprises an enclosure defined by a forward cap separated along a central axis from an aft cap by an enclosure skin; the forward cap comprising at least one mounting pad, wherein the at least one mounting pad is attachable to one or more mounting brackets; and an auxiliary power unit interface flange attached to the forward cap and depending axially away from the forward cap, wherein the auxiliary power unit interface flange is capable of engaging the auxiliary power unit, and wherein the auxiliary power unit interface flange is capable of providing support for the auxiliary power unit; the aft cap comprising a plurality of aft cap outer sides perpendicular to the central axis and circumscribing the central axis; the aft cap having an exhaust hole disposed about the central axis through the aft cap.

In yet another aspect of the invention, a modular installation kit for mounting an auxiliary power unit in a vehicle comprises an enclosure defined by a forward cap separated along a central axis from an aft cap by an enclosure skin; the forward cap comprising a front face located perpendicular to the central axis; a mounting face located on a side of the forward cap opposite the front face; a plurality of forward cap outer sides perpendicular to the front face and the mounting face, circumscribing the central axis; each of the plurality of outer sides having a forward cap mounting pad extending axially away from the mounting face in a direction opposite from the front face, wherein at least one of the forward cap mounting pads is attachable to one or more mounting brackets attachable to the vehicle; the forward cap having an inlet hole disposed about the central axis through the front face and the mounting face; an auxiliary power unit interface flange circumscribing the inlet hole and depending axially away from the mounting face in a direction opposite the front face; wherein the auxiliary power unit interface flange is capable of engaging an auxiliary power unit, and wherein the auxiliary power unit interface flange is capable of providing support for the auxiliary power unit; the aft cap comprising an aft cap inner face located perpendicular to the central axis; an aft cap outer face located on a side of the aft cap opposite the aft cap inner face; and a plurality of aft cap outer sides perpendicular to the central axis and circumscribing the central axis; each of the plurality of aft cap outer sides having an aft cap mounting pad extending axially away from the aft cap inner face along the central axis in a direction opposite from the aft cap outer face, wherein at least one of the aft cap mounting pads is attachable to one or more mounting brackets attachable to the vehicle; the aft cap having an exhaust hole disposed through the aft cap inner face and the aft cap outer face; the enclosure skin being attached to the plurality of forward cap mounting pads at a front enclosure end, and the enclosure skin being attached to one or more of the aft cap mounting pads at an aft enclosure end, wherein the auxiliary power unit is disposable within the enclosure.

In still a further aspect of the invention a modular auxiliary power unit assembly comprises an enclosure defined by a forward cap separated along a central axis from an aft cap by an enclosure skin; an auxiliary power unit disposed within the enclosure; the forward cap comprising a front face located perpendicular to the central axis; a mounting face located on a side of the forward cap opposite the front face; a plurality of forward cap outer sides perpendicular to the front face and the mounting face, circumscribing the central axis; each of the plurality of outer sides having a mounting pad extending axially away from the mounting face along the central axis in a direction opposite from the front face, wherein at least one of the mounting pads is attachable to one or more mounting brackets attachable to the vehicle; the forward cap having an inlet hole radially disposed about the central axis through the front face and the mounting face; an auxiliary power unit interface flange circumscribing the inlet hole and depending axially away from the mounting face in a direction opposite the front face; wherein the auxiliary power unit interface flange is capable of engaging an inlet to, and providing support for the auxiliary power unit; the forward cap further comprising at least one connection disposed on the forward cap to provide communication between the auxiliary power unit and one or more systems on the vehicle; the aft cap comprising an aft cap inner face located perpendicular to the central axis; an aft cap outer face located on a side of the aft cap opposite the aft cap inner face; and a plurality of aft cap outer sides perpendicular to the central axis and circumscribing the central axis; the aft cap having an exhaust hole radially disposed about the central axis through the aft cap inner face and the aft cap outer face; the enclosure skin being attached to the plurality of forward cap outer sides at a front enclosure end, and the enclosure skin being attached to one or more of the aft cap outer sides at an aft enclosure end.

In yet a further aspect of the present invention, a method of mounting an auxiliary power unit in a vehicle comprises the steps of A) attaching an auxiliary power unit to a modular installation kit to produce an auxiliary power unit assembly, the kit comprising a forward cap comprising at least one mounting pad, wherein said at least one mounting pad is attachable to one or more mounting brackets; and an auxiliary power unit interface flange attached to said forward cap and depending axially away from said forward cap, wherein said auxiliary power unit interface flange is capable of engaging said auxiliary power unit, and wherein said auxiliary power unit interface flange is capable of providing support for said auxiliary power unit; and B) attaching the auxiliary power unit assembly to the vehicle by attaching the one or more mounting brackets to the vehicle.

These and other features, aspects and advantages of the present invention will become better understood with reference to the following drawings, description and claims.

### BRIEF DESCRIPTION OF THE DRAWINGS

FIG. 1 is an isometric view of a modular installation kit according to an embodiment of the present invention, aft looking forward;

FIG. 2 is an isometric view of a modular installation kit according to an embodiment of the present invention, forward looking aft;

FIG. 3 is a cross-sectional overhead view of a modular installation kit according to an embodiment of the present invention;

FIG. 4 is a side view of an exhaust system of a modular installation kit according to an embodiment of the present invention;

FIG. 5A is a perspective view of an individual housing member of a modular installation kit according to an embodiment of the present invention;

FIG. 5B is a perspective view of a single housing member assembly of a modular installation kit according to an embodiment of the present invention;

FIG. 6 is a perspective view of a front face of a modular installation kit according to another embodiment of the present invention, forward looking aft;

FIG. 7 is a perspective view of a modular installation kit according to another embodiment of the present invention, forward looking aft; and

FIG. 8 is a block diagram depicting the steps of a method for installing an APU according to another embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides a modular installation kit and methods for installing an APU, for example, in a vehicle such as an aircraft. This is in contrast to the prior art wherein the means for mounting the APU to a vehicle and the dimensions of each APU are specifically tailored to a particular end use such as in a particular aircraft.

Also, the present invention may include a plurality of mounting pads, any one of which may be used alone, or in combination with other mounting pads, to attach the APU consistent with the end use, e.g., attaching in a vehicle. This also is in contrast to the prior art, wherein each APU was designed to fit within a particular space of a vehicle utilizing particular attachment points.

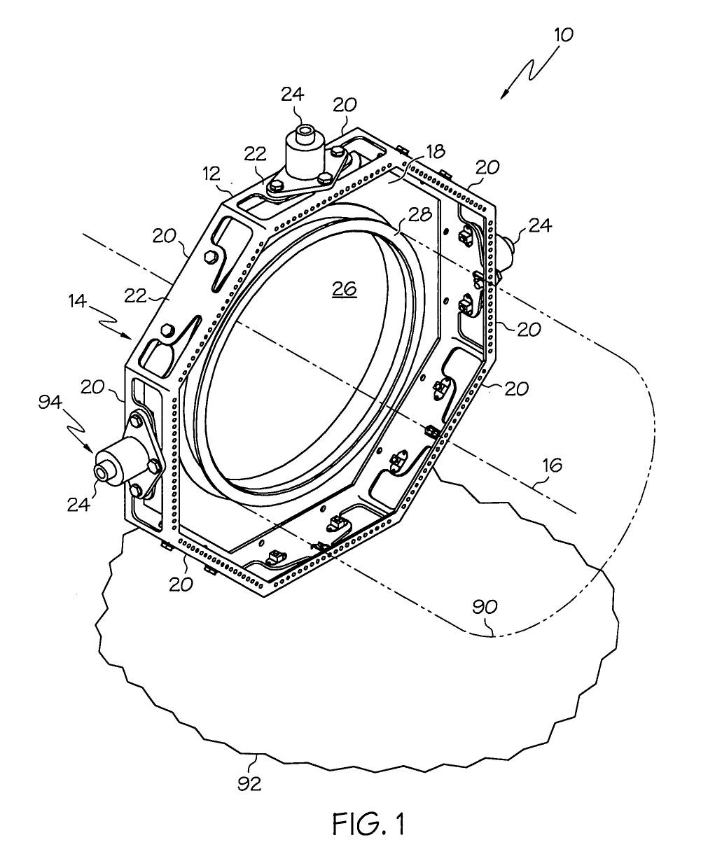

In more specifically describing the present invention, FIG. 1 shows a rear perspective view of a modular installation kit according to an embodiment of the present invention. The modular installation kit, represented generally as 10, for mounting an APU 90 in a vehicle 92 may comprise a forward cap 12 having a front face 14 located substantially perpendicular to a central axis 16. Forward cap 12 may also include a mounting face 18 located on a side of forward cap 12 which is opposite front face 14. The outer perimeter of forward cap 12 may be comprised of a plurality of outer sides 20, which are arranged perpendicular to front face 14 and mounting face 18. These outer sides 20 circumscribe central axis 16.

At least one, and preferably each, of the plurality of outer sides 20 may have a mounting pad 22 (only two of which are numbered in FIG. 1 for clarity) extending axially away from mounting face 18 along central axis 16 in a direction opposite front face 14. In an embodiment, at least one of the mounting pads 22 may be attachable to one or more mounting brackets 24, which may be attachable to vehicle 92.

Forward cap 12 may also have an inlet opening or inlet hole 26 disposed through front face 14 and mounting face 18. In an embodiment, an auxiliary power unit interface flange, also referred to as an APU interface flange 28, may circumscribe inlet hole 26. As shown in FIG. 1, APU interface flange 28 may depend axially away from mounting face 18 along central axis 16 in a direction opposite front face 14. APU interface flange 28 may also be capable of engaging an inlet to APU 90, and may also be able to provide support for APU 90.

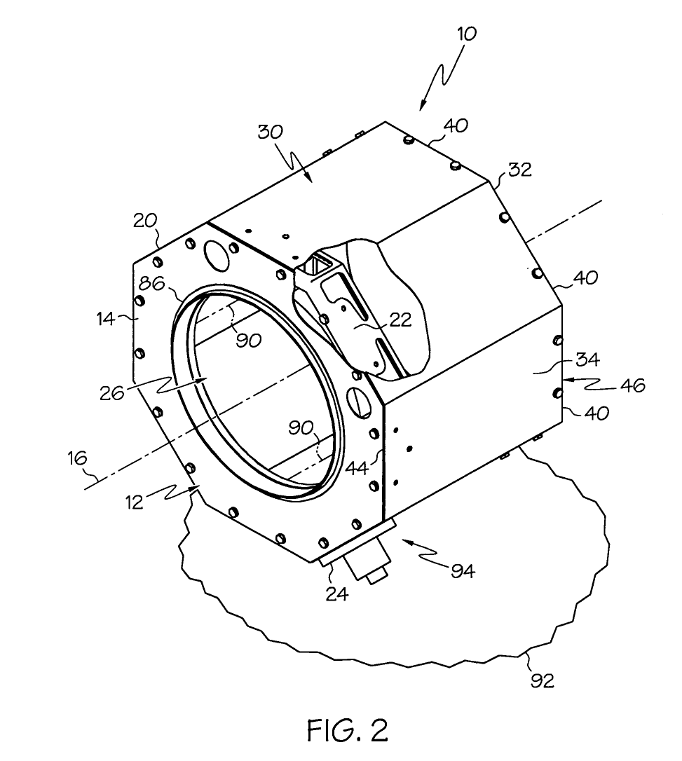

Referring now to FIG. 2, modular installation kit 10 for mounting an APU 90 in vehicle 92 may further comprise an enclosure 30 defined by forward cap 12 separated along central axis 16 from an aft cap 32 by an enclosure skin 34. APU 90 may be entirely enclosed within enclosure 30. Forward cap 12, as described previously, may include front face 14 located perpendicular to central axis 16, and a plurality of forward cap outer sides perpendicular to front face 14 that may circumscribe central axis 16.

As shown in the cut-away view of FIG. 2, each of the outer sides 20 may having a mounting pad 22 extending axially away from mounting face 18 (see FIG. 1) along central axis 16 in a direction opposite from front face 14. In an embodiment, at least one of the mounting pads 22 is attachable to one or more mounting brackets 24 of mounting system 94, which may be attachable to vehicle 92.

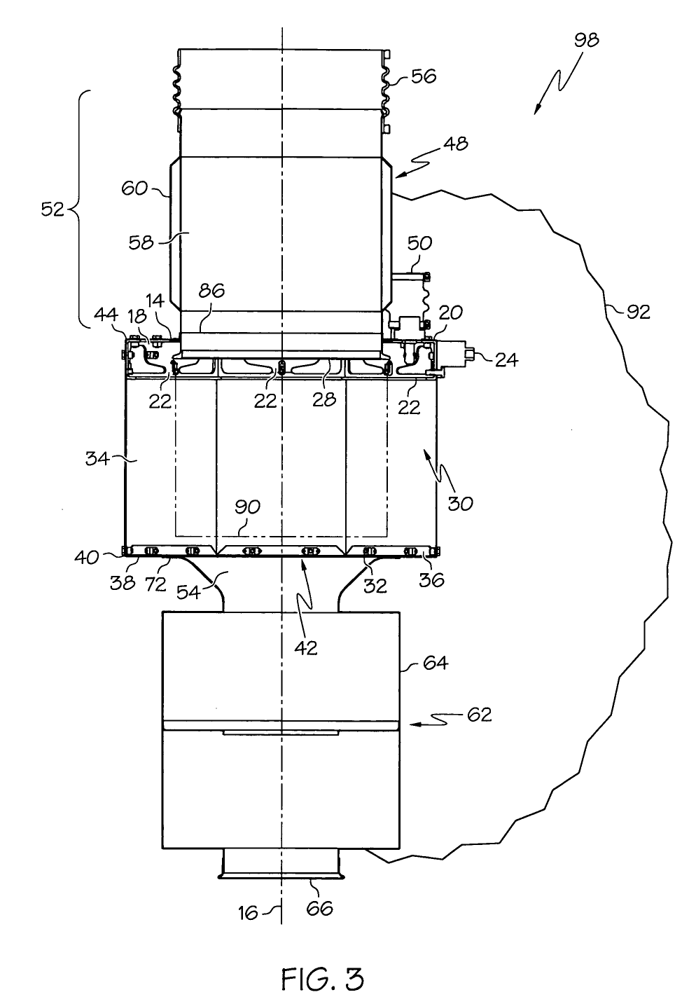

As shown in the cross-sectional view of FIG. 3, aft cap 32 may comprise an aft cap inner face 36 located perpendicular to central axis 16. Aft cap 32 may also include an aft cap outer face 38 located on a side of aft cap 32 opposite aft cap inner face 36. Aft cap 32 may also include a plurality of aft cap outer sides 40 (see FIG. 2) which may be located perpendicular to central axis 16, and which may circumscribe central axis 16. Aft cap 32 may also have an exhaust hole 42 which may be radially disposed about central axis 16 through aft cap inner face 36 and aft cap outer face 38.

Enclosure skin 34 may be attached to one or more mounting pads 22 at a front enclosure end 44. Enclosure skin 34 may also be attached to one or more aft cap outer sides 40 at an aft enclosure end 46 (see FIG. 2). In an embodiment, the APU 90 may be disposed within enclosure 30/enclosure skin 34.

The mount system 94 of modular installation kit 10 may thus provide apparatus to install APU 90 into several different end use applications, such as different types and models of vehicle 92, without the need to change mounting brackets and other provisions on APU 90. This is accomplished by eliminating the use of pad and flange adapters disposed directly on prior art APUs. Instead, in the present invention, an auxiliary power unit interface flange, also referred to as an APU interface flange 28, may be dimensioned and arranged to engage APU 90.

APU interface flange 28 may be an integral part of modular installation kit 10. As such, one of the primary structural components of APU 90 may be a flange or other mating surface on the inlet (not shown) of APU 90, dimensioned and arranged so as to engage APU interface flange 28. In an embodiment, the mating flange on the APU may be arranged in such a way as to fully support APU 90. This may allow a single configuration of APU 90 to be used on a variety of vehicles 92 when modular installation kit 10 of the present invention is employed.

APU interface flange 28 may thus provide a mechanism to interface with APU 90 equipped with a corresponding APU mating flange (not shown) e.g., a mount ring (not shown) on APU 90 dimensioned and arranged to be engagable with APU interface flange 28 disposed on modular installation kit 10. In an embodiment of the present invention, APU interface flange 28 may be an integral part of an inlet system 48 for modular installation kit 10. In an embodiment, APU interface flange 28 may be circular or a near-circular polygonal shape to provide APU 90 attachment to vehicle 92. APU interface flange 28, in conjunction with forward cap 14, may thus transmit operational and inertial APU loads (not shown) from APU 90 to mount system 94, e.g., to mounting brackets 24. These loads may then be transferred to the frame of vehicle 92, e.g., to the airframe of an aircraft.

As is also shown in FIG. 3, inlet system 48 may include various subsystems such as an enclosure cooling duct connection 50 and an inlet duct assembly 52, which may attach to interface flange 28 on a side opposite APU 90.

Enclosure cooling duct connection 50 may supply outside air (not shown) into enclosure 30 to reduce the temperature within enclosure 30 and to assist in cooling APU 90. Enclosure cooling duct connection 50 may also act in conjunction with an exhaust system eductor 54 to ensure continuous airflow through enclosure 30 while APU 90 is operating.

Inlet duct assembly 52 may also provide outside air (not shown) to APU 90 in support of various functions of APU 90, e.g., a pneumatic power compressor, the combustor, and the like (not shown). Additionally, inlet duct assembly 52 may provide noise attenuation, fire containment, and installation misalignment compensation.

Inlet system 48 may comprise a flexible duct 56, which may also be fireproof, and which may accommodate misalignment of the type seen in modern APU 90 installations. Inlet system 48 may also comprise a rigid or semi-rigid section of ductwork 58 which may comprise various forms of acoustic treatment 60. Acoustic treatment 60 may reduce the amount of inlet noise observed by vehicle operators.

Also shown in FIG. 3, modular installation kit 10 may further include an exhaust system 62 that may provide a flow path that will safely transport APU exhaust gases (not shown) overboard vehicle 92. Additionally, exhaust system 62 may include a muffler 64, to reduce APU exhaust noise, prior to an exhaust outlet 66. Exhaust system eductor 54 may be in the form of a bellmouth that may work in conjunction with the inlet system 48 to provide cooling air for APU 90 and enclosure 30 as discussed above. Exhaust system 62 may be attached to aft cap 32 via an exhaust flange 72 radially disposed about exhaust hole 42. Accordingly, exhaust flange 72 may be attachable to exhaust system 62 e.g., via exhaust system eductor 54.

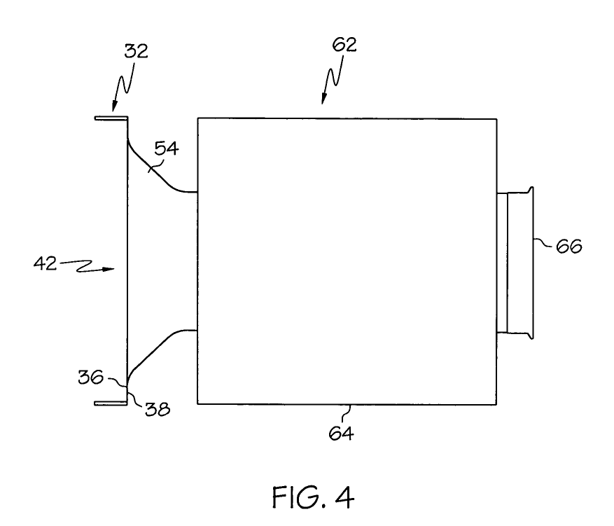

As shown in the embodiment of FIG. 4, aft cap 32 and exhaust system eductor 54 may also be combined into a single assembly, thus exhaust system 62 may comprise aft cap 32.

Modular installation kit 10 may be fabricated to provide a fire containment system in the form of enclosure 30, being fabricated from fireproof materials around the APU, and the fireproof construction of inlet system 48 and exhaust system 62. Examples of suitable fireproof materials include metal and metal alloys of titanium, aluminum, iron, and the like. Fiber-reinforced plastic composites including carbon fiber reinforced graphite-bismaleimide, graphite-phenolic, and the like may also be used, as known to one of skill in the art. Other fiber-reinforced plastics with proven fireproof characteristics are also suitable.

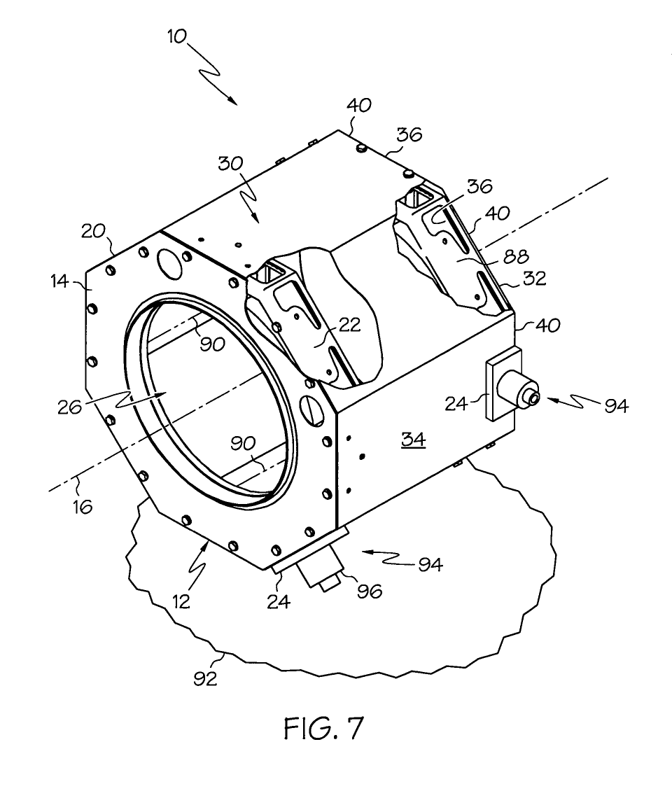

In an embodiment shown in FIG. 7, modular installation kit 10 may further include a circular inlet hole 26. In an embodiment, inlet hole 26 may be coaxial with central axis 16. Further, modular installation kit 10 may comprise an inlet duct flange 86 (see FIG. 2) circumscribing inlet hole 26, and depending axially away from front face 14 along central axis 16 in a direction opposite mounting face 18 (see FIG. 1). The inlet duct flange 86 may also be capable of engaging an inlet duct assembly 52 (see FIG. 3).

In another embodiment, modular installation kit 10 for mounting APU 90 in vehicle 92 may further include aft cap 32, which may comprise a plurality of aft cap outer sides 40 arranged perpendicular to central axis 16 and circumscribing central axis 16, wherein at least one, and preferably each, of the plurality of aft cap outer sides 40 may have an aft cap mounting pad 88 extending axially away from aft cap inner face 36 along central axis 16 in a direction opposite from aft cap outer face 38. At least one of the aft cap mounting pads 88 may be attachable to one or more mounting brackets 24, the latter adapted for affixation to vehicle 92 as part of mounting system 94.

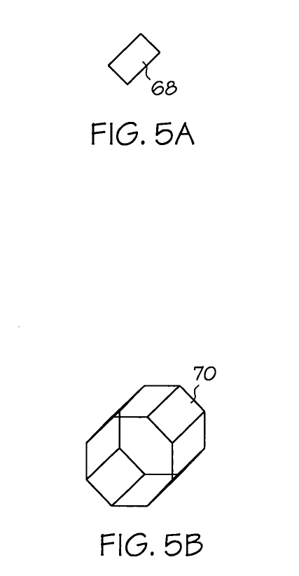

Enclosure 30 thus may include at least three components: enclosure skin 34, forward cap 12, and aft cap 32. In an embodiment, enclosure skin 34 may be of the same shape and dimension as the shape formed by the forward cap outer sides 20, where enclosure skin 34 attaches thereto. In an embodiment shown in FIG. 5A, enclosure skin 34 may comprise a plurality of individual housing members 68. In another embodiment shown in FIG. 5B, enclosure skin 34 may comprise a single housing member assembly 70.

Forward cap 12 of modular installation kit 10 may further include at least four or more outer sides 20, or at least five outer sides 20, or at least six outer sides 20, or at least eight outer sides 20, or at least ten outer sides 20, or at least twelve outer sides 20, or an infinite number of outer sides 20.

Mounting system 94 of modular installation kit 10 may comprise at least two mounting pads 22, which are attachable to one or more mounting brackets 24, which are attachable to vehicle 92, or at least three mounting pads 22, or at least four mounting pads 22, or each of the plurality of mounting pads 22 may be attachable to one or more mounting brackets attachable to vehicle 92. In an embodiment one or more mounting brackets 24 may comprise a vibration isolator 96.

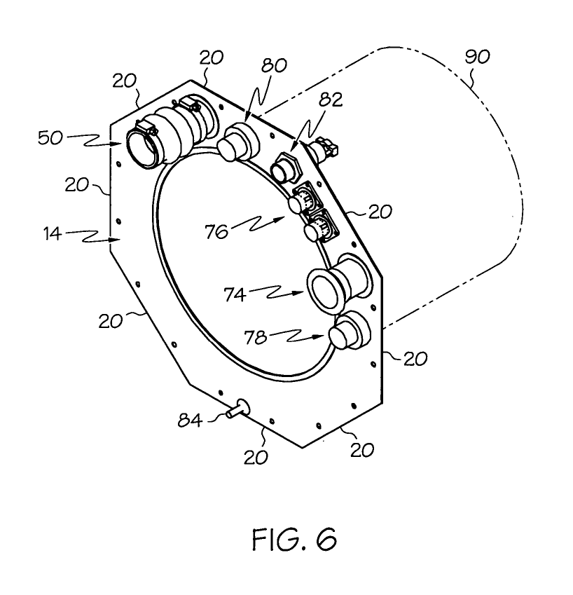

Modular installation kit 10 may also provide communication between the APU 90 and one or more other systems of vehicle 92. As shown in FIG. 6, front face 14 of forward cap 12 may include at least one connection to provide communication between the APU 90 and one or more systems on the vehicle 92, wherein at least one connection may comprise, for example, an electrical power distribution connection 76, a pneumatic power connection 74, a fuel supply connection 78, an enclosure cooling duct connection 50, a fire extinguishant connection 80, a wiring harness connection 82, or a combination thereof.

The fire extinguishant connection 80 may mate with a vehicle fire bottle (not shown) located outside enclosure 30, and fire extinguishant connection 80 may act to distribute an extinguishing agent (not shown) in the event of a fire inside enclosure 30.

Wiring harness connection 82 may include an industry standard bulkhead connector mounted to front face 14. Inside enclosure 30, a branched wiring harness (not shown) may be provided to connect the various sensors and controls on the APU to wiring harness connection 82.

Electrical power distribution connection 76 may include an industry standard bulkhead connector mounted to front face 14. Inside enclosure 30, electrical power cables (not shown) may be used to connect the APU's electrical power generator (not shown) to electrical power distribution connection 76.

Fuel supply connection 78 may include an industry standard bulkhead connector mounted to front face 14. Inside enclosure 30, a fuel hose (not shown) may connect the APU's fuel port (not shown) to fuel supply connection 78.

Modular installation kit 10 may also include one or more of a drain system connection 84, which may include a bulkhead connector mounted to front face 14. The location of drain system connection 84 may vary depending on the attitude of modular installation kit 10 as installed in a particular vehicle. Inside the enclosure 30, a drain tube (not shown) may connect the APU's drain port (not shown) to one or more of a drain system connection 84.

All of these connections may be located at any convenient point on modular installation kit 10. In an embodiment, all of the system connections may be mounted on forward cap 12 of enclosure 30 so that the majority of the vehicle connections are centrally located. Also, two or more of the connections may be incorporated into a single connector.

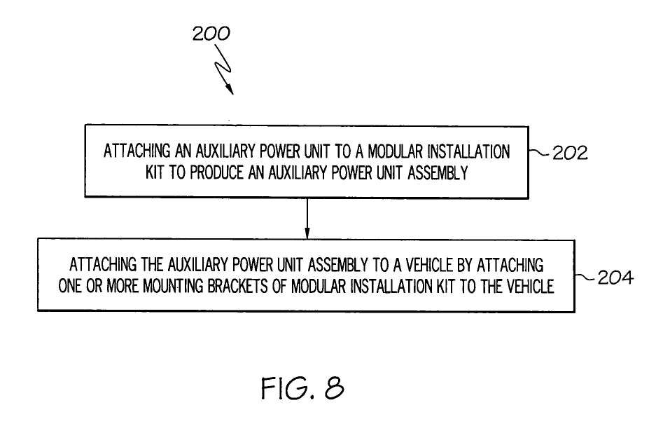

In a further embodiment of the present invention, a method 200 of mounting an APU 90 in vehicle 92, as shown in block diagram form in FIG. 8, may comprise attaching an APU 90 to a modular installation kit 10 to produce an auxiliary power unit assembly 98 (step 202), wherein the modular installation kit 10 may have various elements, features, and characteristics as described hereinabove with respect to FIGS. 1-7. Thereafter, step 202 may be followed by a step of attaching APU assembly 98 to a vehicle, e.g., to vehicle 92, by attaching one or more mounting brackets 24 of modular installation kit 10 to vehicle 92 (Step 204).

It should be understood, of course, that the foregoing relates to exemplary embodiments of the invention and that modifications may be made without departing from the spirit and scope of the invention as set forth in the following claims.

We claim:

1. A modular installation kit for mounting an auxiliary power unit, said kit comprising:
a forward cap comprising at least one mounting pad, wherein said at least one mounting pad is attachable to one or more mounting brackets; and
an auxiliary power unit interface flange attached to said forward cap and depending axially away from said forward cap, wherein said auxiliary power unit interface flange is capable of engaging said auxiliary power unit, and wherein said auxiliary power unit interface flange is capable of providing support for said auxiliary power unit.

2. The modular installation kit of claim 1, wherein said forward cap further comprises a front face located perpendicular to a central axis, and a mounting face located on a side of said forward cap opposite said front face;
a plurality of outer sides perpendicular to said front face and said mounting face, said plurality of outer sides circumscribing said central axis;
wherein at least one of said plurality of outer sides comprises said at least one mounting pad extending axially away from said mounting face in a direction opposite said front face.

3. The modular installation kit of claim 2, wherein said forward cap further comprises an inlet hole disposed through said front face and through said mounting face; and wherein said auxiliary power unit interface flange circumscribes said inlet hole and depends axially away from said mounting face in a direction opposite said front face.

4. The modular installation kit of claim 2, wherein said forward cap comprises at least four outer sides.

5. The modular installation kit of claim 2, wherein said forward cap comprises at least eight outer sides.

6. The modular installation kit of claim 2, wherein said forward cap comprises at least ten outer sides.

7. The modular installation kit of claim 2, wherein said forward cap comprises at least twelve outer sides.

8. The modular installation kit of claim 2, wherein said forward cap comprises an infinite number of outer sides.

9. The modular installation kit of claim 1, comprising at least two mounting pads attachable to said one or more mounting brackets.

10. The modular installation kit of claim 1, comprising at least three mounting pads attachable to said one or more mounting brackets.

11. The modular installation kit of claim 1, comprising at least four mounting pads attachable to said one or more mounting brackets.

12. The modular installation kit of claim 1, wherein each of said mounting pads are attachable to said one or more mounting brackets.

13. The modular installation kit of claim 3, wherein said inlet hole is circular.

14. The modular installation kit of claim 13, wherein said inlet hole is coaxial with said central axis.

15. The modular installation kit of claim 3, further comprising an inlet duct flange circumscribing said inlet hole and depending axially away from said front face along said central axis in a direction opposite said mounting face; wherein said inlet duct flange is capable of engaging an outlet of an inlet duct assembly.

16. A modular installation kit for mounting an auxiliary power unit in a vehicle, said kit comprising:
an enclosure defined by a forward cap separated along a central axis from an aft cap by an enclosure skin;
said forward cap comprising at least one mounting pad, wherein said at least one mounting pad is attachable to one or more mounting brackets;
and an auxiliary power unit interface flange attached to said forward cap and depending axially away from said forward cap, wherein said auxiliary power unit interface flange is capable of engaging said auxiliary power unit, and wherein said auxiliary power unit interface flange is capable of providing support for said auxiliary power unit;
said aft cap comprising a plurality of aft cap outer sides perpendicular to said central axis and circumscribing said central axis;
said aft cap having an exhaust hole disposed about said central axis through said aft cap.

17. The modular installation kit of claim 16, wherein said enclosure is fireproof.

18. The modular installation kit of claim 16, wherein said enclosure comprises a fiber reinforced plastic composite.

19. The modular installation kit of claim 16, wherein said enclosure skin comprises a plurality of housing members.

20. The modular installation kit of claim 16, wherein said enclosure skin comprises a single housing member assembly.

21. The modular installation kit of claim 16, wherein said one or more mounting brackets comprise a vibration isolator.

22. The modular installation kit of claim 16, wherein said aft cap comprises an exhaust flange radially disposed about said exhaust hole, and wherein said exhaust flange is attachable to an exhaust system.

23. The modular installation kit of claim 16, wherein said enclosure skin and said aft cap comprise a single member.

24. A modular installation kit for mounting an auxiliary power unit in a vehicle, said kit comprising:
an enclosure defined by a forward cap separated along a central axis from an aft cap by an enclosure skin;
said forward cap comprising a front face located perpendicular to said central axis;
a mounting face located on a side of said forward cap opposite said front face;
a plurality of forward cap outer sides perpendicular to said front face and said mounting face, circumscribing said central axis;
each of said plurality of outer sides having a forward cap mounting pad extending axially away from said mounting face in a direction opposite from said front face, wherein at least one of said forward cap mounting pads is attachable to one or more mounting brackets attachable to said vehicle;
said forward cap having an inlet hole disposed about said central axis through said front face and said mounting face;
an auxiliary power unit interface flange circumscribing said inlet hole and depending axially away from said mounting face in a direction opposite said front face;
wherein said auxiliary power unit interface flange is capable of engaging said auxiliary power unit, and wherein said auxiliary power unit interface flange is capable of providing support for said auxiliary power unit;
said aft cap comprising an aft cap inner face located perpendicular to said central axis;
an aft cap outer face located on a side of said aft cap opposite said aft cap inner face; and
a plurality of aft cap outer sides perpendicular to said central axis and circumscribing said central axis;
each of said plurality of aft cap outer sides having an aft cap mounting pad extending axially away from said aft cap inner face along said central axis in a direction opposite from said aft cap outer face, wherein at least one of said aft cap mounting pads is attachable to one or more mounting brackets attachable to said vehicle;
said aft cap having an exhaust hole disposed through said aft cap inner face and said aft cap outer face;
said enclosure skin being attached to said plurality of forward cap mounting pads at a front enclosure end, and said enclosure skin being attached to one or more of said aft cap mounting pads at an aft enclosure end, wherein said auxiliary power unit is disposable within said enclosure.

25. A modular auxiliary power unit assembly comprising:
an enclosure defined by a forward cap separated along a central axis from an aft cap by an enclosure skin;
an auxiliary power unit disposed within said enclosure;
said forward cap comprising a front face located perpendicular to said central axis;
a mounting face located on a side of said forward cap opposite said front face;
a plurality of forward cap outer sides perpendicular to said front face and said mounting face, circumscribing said central axis;
each of said plurality of outer sides having a mounting pad extending axially away from said mounting face along said central axis in a direction opposite from said front face, wherein at least one of said mounting pads is attachable to one or more mounting brackets attachable to a vehicle;
said forward cap having an inlet hole radially disposed about said central axis through said front face and said mounting face;
an auxiliary power unit interface flange circumscribing said inlet hole and depending axially away from said mounting face in a direction opposite said front face;
wherein said auxiliary power unit interface flange is capable of engaging an inlet to, and providing support for said auxiliary power unit;
said forward cap further comprising at least one connection disposed on said forward cap to provide communication between said auxiliary power unit and one or more systems on said vehicle;
said aft cap comprising an aft cap inner face located perpendicular to said central axis;
an aft cap outer face located on a side of said aft cap opposite said aft cap inner face; and
a plurality of aft cap outer sides perpendicular to said central axis and circumscribing said central axis;
said aft cap having an exhaust hole radially disposed about said central axis through said aft cap inner face and said aft cap outer face;
said enclosure skin being attached to said plurality of forward cap outer sides at a front enclosure end, and said enclosure skin being attached to one or more of said aft cap outer sides at an aft enclosure end.

26. The modular auxiliary power unit assembly of claim 25, wherein said at least one connection comprises an electrical power distribution connection, a pneumatic power connection, a fuel supply connection, an enclosure cooling duct connection, a fire extinguishant connection, a wiring harness connection, or a combination thereof.

27. The modular auxiliary power unit assembly of claim 26, wherein at least two or more of said at least one connections are incorporated into a single connector.

28. A method of mounting an auxiliary power unit in a vehicle, comprising the steps of:
A) attaching an auxiliary power unit to a modular installation kit to produce an auxiliary power unit assembly, the kit comprising a forward cap comprising at least one mounting pad, wherein said at least one mounting pad is attachable to one or more mounting brackets; and an auxiliary power unit interface flange attached to said forward cap and depending axially away from said forward cap, wherein said auxiliary power unit interface flange is capable of engaging said auxiliary power unit, and wherein said auxiliary power unit interface flange is capable of providing support for said auxiliary power unit; and
B) attaching said auxiliary power unit assembly to said vehicle by attaching said one or more mounting brackets to said vehicle.
